(19) United States
(12) Patent Application Publication
(10) Pub. No.: US 2016/0271643 A1
(43) Pub. Date: Sep. 22, 2016

(54) SYSTEM AND METHOD FOR IMPROVED RUNNABILITY OF SHEET FED AND ROLL FED COATERS

(71) Applicant: MANUEL JOSE MUNOZ, CALI (CO)

(72) Inventor: MANUEL JOSE MUNOZ, CALI (CO)

(21) Appl. No.: 14/664,874

(22) Filed: Mar. 22, 2015

(51) Int. Cl. B05D 1/02; B05B 9/03; B05D 1/28

(52) U.S. Cl. CPC B05D 1/02; B05D 1/28; B05B 9/03

(57) ABSTRACT

A system and method for improved runnability of sheet fed and roll fed coaters comprising of a steam system and a conventional sheet fed coater. Headers of the steam system are positioned in such a way that steam from the steam system can be sprayed at the desired position over the rollers of conventional sheet fed coater. The steam system allows control of pressure, temperature, flow etc. of the steam sprayed over the rollers. The steam spray lubricates the coating roller and prevents lightweight thin substrates like paper or film etc. from sticking onto the surface of the coating roller. The present invention makes it possible to coat a lightweight thin substrate up to the edges of the substrate as clamps are not required to hold the substrate at the exit of the coater. The steam also helps to prevent drying up of coating substance over the roller surface.

### FIELD OF THE INVENTION

The present invention relates to sheet fed and roll fed (also known as web fed) roller coaters. More particularly, the present invention relates to sheet fed and web fed coaters for lightweight thin material coated with low and high viscosity coating chemicals.

### BACKGROUND OF THE INVENTION

Use of roller coaters for applying liquid coatings to substrates is very common. In roller coaters, the part being coated is made to pass over and/or through one or more rollers to apply coat of liquid substances such as overprint varnishes, primers, functional barrier coatings, paints, oils, adhesives, chemicals etc. In case of sheet fed coaters, individual sheets of substrates are fed through roller coaters. The lightweight individual sheets of substrates, for example, paper of 150 gsm (grams per square meter) or less in Basis Weight or 180 micron thickness or less, being coated are required to be gripped by some kind of gripping mechanism to facilitate release of the sheets from the rollers of the coating machine. During the exit of an individual sheet of substrate, it often happens that the lightweight substrate having lesser rigidity gets pasted on any of the rollers. This problem is particularly serious when the substrate being coated is a lightweight paper (including synthetic paper), a film or a similar material having lesser stiffness. Once a substrate gets pasted to a roller, the coating machine has to be stopped to pull the substrate away from the roller and clean the system resulting increased downtime of the coating machine. In addition, in case of lightweight substrates, in sheet fed coaters, it is not possible to apply the coat to that part of the substrate sheet that is being held by the gripper to pull it away from the rollers. Even with gripper mechanism, in many coating applications, the lightweight thin material gets pasted onto the rollers and causes downtime. Sometimes the coating liquid gets dried up and scales of dried coating material get accumulated over the coating rollers adversely affecting the performance of the coating machine, reducing the coating weight that is transferred to the substrate to a point that, sometimes, the substrate does not get coated and, as a consequence, further reduces quality and increases rejection problems in the coating process.

On web fed coaters, the same complication appears and customers suffer runnability problems. In the case of roll fed coater, the bigger problem is the reduced speed and/or the down time for maintenance.

Sheets having higher weight or thicker sheets and webs can also experience similar problems with less downtime for maintenance or rejects.

There is, therefore, a need for a system and method that improves performance of various types of roller coaters including sheet fed and web fed coaters.

### OBJECTS OF THE INVENTION

An object of the present invention is to provide a system and method that prevents lightweight substrate material from sticking onto rollers of a sheet fed and web fed coating machines.

Another object of the present invention is to provide a system and method for coating lightweight thin material up to the extreme ends of the material in a sheet fed roller coating machine.

Yet another object of the present invention is to provide a system and method for avoiding drying of coating material on the rollers of a sheet fed and web fed coating machines.

Still further object of the present invention is to provide a system and method for preventing build-up of coating material on the rollers of a sheet fed and web fed coating machines.

A further object of the present invention is to provide a system and method for increasing productivity of sheet fed and web fed roller coating machines by decreasing machine downtime happening due to jamming of lightweight substrate materials.

Yet another object of the present invention is to provide a system and method that enables coating on lightweight and thin paper including synthetic paper or films in a sheet fed and web fed roller coating machine.

Another object of the present invention is to provide a system and method for increasing speed of coating lightweight material in a sheet fed and web fed roller coaters.

A further object of the present invention is to provide a system and method for increasing productivity of all those coaters that have issues with pasting.

Yet another object of the present invention is to provide a system and method for improved runnability of sheet fed and roll fed coaters.

Another object of the present invention is to provide a system and method for avoiding curling of lightweight and heavyweight papers while coating with water based coating in sheet fed and web fed coating machines.

These as well as other objects of the present invention are apparent upon inspection of this specification, including the drawings and appendices attached hereto.

### SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The present invention is directed to a system and method for improved sheet fed and web fed coaters. In the conventional sheet fed coaters it is very difficult to coat lightweight and/or thin materials such as paper including synthetic paper below 150 gsm of Basis Weight or 180 micron thickness. Such lightweight substrates can get pasted on the surface of the coating rollers which may lead to jamming of the coating machine. If a substrate gets pasted on a roller, then the coating machine is required to be stopped to pull the substrate out of the roller surface with the help of some kind of suitable tool. To return the coating machine to an operable situation, the rollers have to be taken out and cleaned before reinstalling those to start again. The system and method of the present invention incorporates a steam system with the conventional sheet fed and web fed coaters to improve the performance of the sheet fed and web fed coaters. The system and method of the present invention improves runnability of sheet fed and roll fed coaters. In accordance with an embodiment of the present invention, steam headers are strategically positioned to inject/spray steam over roller surfaces at desired places. The steam helps to keep the roller surfaces lubricated to prevent sticking of the substrate onto the rollers. The steam also prevents the coating substance from drying up on the surface of the roller which, in turn, reduces stickiness of the coating substance and also reduces build-up of dried coating substance on the rollers. The improved sheet fed and web fed coaters of the present invention enables coating of lightweight and/or thin substrates. The improved sheet fed and web fed coaters of the present invention provides faster coating speed, better coating finish and reduced downtime of the coating machine. In some embodiments, the inventive concept of the present invention can be implemented with a misting system to achieve improved performance of sheet fed and web fed coaters.

To the accomplishment of the foregoing and related ends, certain illustrative aspects of the disclosed invention are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

In order to describe the manner in which features and other aspects of the present disclosure can be obtained, a more particular description of certain subject matter will be rendered by reference to specific embodiments that are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1A shows a conventional metering roll system top coater;

FIG. 1B shows a conventional metering roll system top coater with the sheet or web of substrate getting stuck to the coating roller;

FIG. 2 illustrates a steam spray system in accordance with an embodiment of the present invention;

FIG. 3 illustrates an improved metering roll system top coater in accordance with an embodiment of the present invention;

FIG. 4 illustrates an improved offset press in accordance with one embodiment of the present invention.

### DETAILED DESCRIPTION OF THE INVENTION

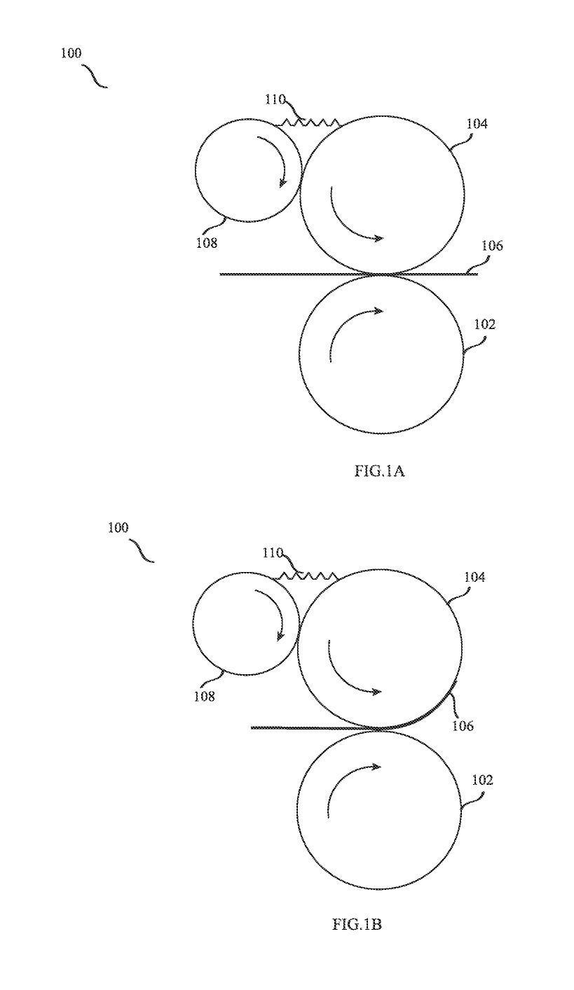

FIG. 1A illustrates a conventional metering roll system top coater 100. As shown in FIG. 1A, object 106 is a substrate that is to be coated. Example of substrate 106 includes, but not limited to, paper including synthetic paper, foil, films, plastic, sheet or web etc. Transport roller 102 drives the substrate 106 in the desired direction. The coating substance 110 is held between the coating roller 104 and doctor roller 108. During the coating process the coating roller 104 carries a layer of the coating substance 110 and a part of this layer of coating substance 110 splits and gets transferred to the surface of the substrate 106 coming in contact with the coating roller 104. The doctor roller 108 controls the thickness of the layer of the coating substance 110 carried by the coating roller 104 and thus controls the thickness of the coating applied on the substrate 106. A part of the coating substance 110 stays on the coating roller surface after the split occurs. The substrate 106, particularly if it is a lightweight and/or thin substrate such as paper, including synthetic paper, foil, films, plastic, sheet or web, having Basis Weight below 150 gsm and/or having thickness below 180 microns and/or having Bending Moment Stiffness or simply Bending Stiffness (Bending Resistance) less than 81 mNm (milliNewton meter) in Machine Direction (MD) and less than 61 mNm in Cross Direction (CD), then the substrate 106 can get pasted on the coating roller 104 as such substrates have lesser degree of rigidity or stiffness than the comparatively thicker or stiffer or more rigid substrates. In FIG. 1B the substrate 106 is shown pasted on surface of the coating roller 104 in conventional sheet fed coater system 100. A lightweight thin substrate 106 can get pasted on any of the other rollers of a conventional sheet fed or web fed coater 100. When a substrate 106 gets pasted on a roller, to pull the substrate 106 away, tools like scrappers or tweezers are used after stopping the coating machine. This increases downtime of the machine. Also, a lightweight substrate or even a heavyweight substrate, when being coated with water based coatings in low and specially in high amounts of coating per square meter, the substrate may suffer from a problem of curling and this makes it difficult to uncurl the substrate and, in turn, causes problems in further applications such as in printing or in photocopying of the coated substrate. Although, only metering roll system top coater 100 is shown in FIG. 1 similar problems occur in every other type of sheet fed coaters such as metering blade coaters, offset coaters, enclosed chamber doctor blade coaters etc. Similar problems also occur in digital printing presses while priming or printing lightweight thin papers or films. Sometimes clamps or similar gripping tools are used to pull lightweight and/or thin substrates at the exit of the coaters that makes it difficult to coat to the extreme ends of the substrate. Hereinafter, the term “sheet fed coater” will be used to refer to all kinds of conventional sheet fed and web fed coaters and digital printing and priming presses used for coating of lightweight and/or thin substrate. Also, hereinafter, alternatively, the term “substrate 106” will be used to refer to all kinds of lightweight and/or thin substrates such as papers (including synthetic papers), lamina material, film etc. both in sheets or webs. Also, hereinafter, alternatively, the term “steam” will be used to refer mist.

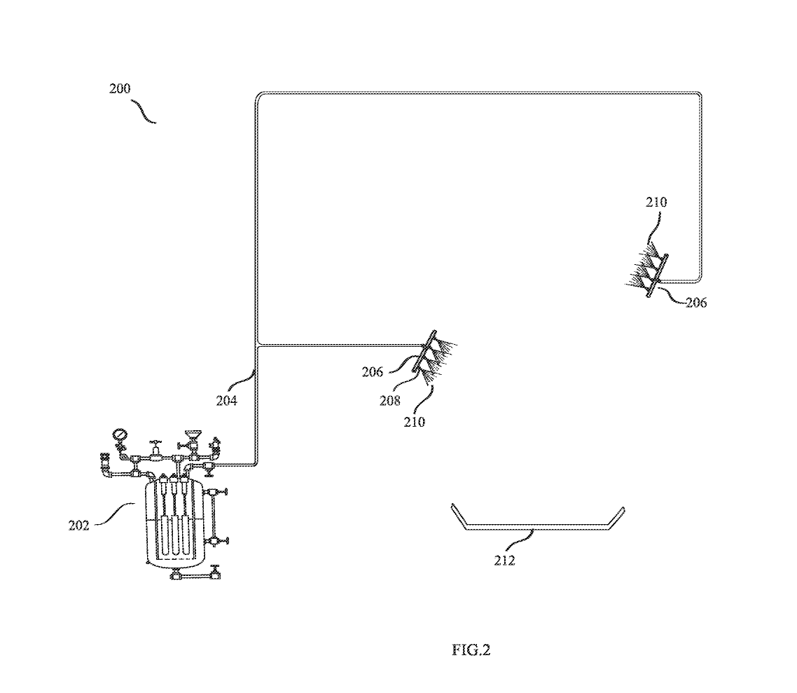

FIG. 2 illustrates a steam system 200 in accordance with an embodiment of the present invention. Steam generator 202 can be a fuel fired boiler or electrical boiler or any other conventional type of device capable of generating steam from a fluid. Examples of fluid used for steam generation includes, but not limited to, water or solvents. A control system comprising of valves and regulators and sensors can be used to control/regulate the flow/pressure/temperature of steam supplied by the steam generator 202. The steam generated by the steam generator 202 can be then taken to one or more headers 206 through pipelines 204. Headers 206 may comprise of one or more nozzles 208 for releasing steam spray 210. In some embodiments, a steam condensate collector 212 can be used as a part of the steam system 200 to collect the condensate that can be again fed to the steam generator 202.

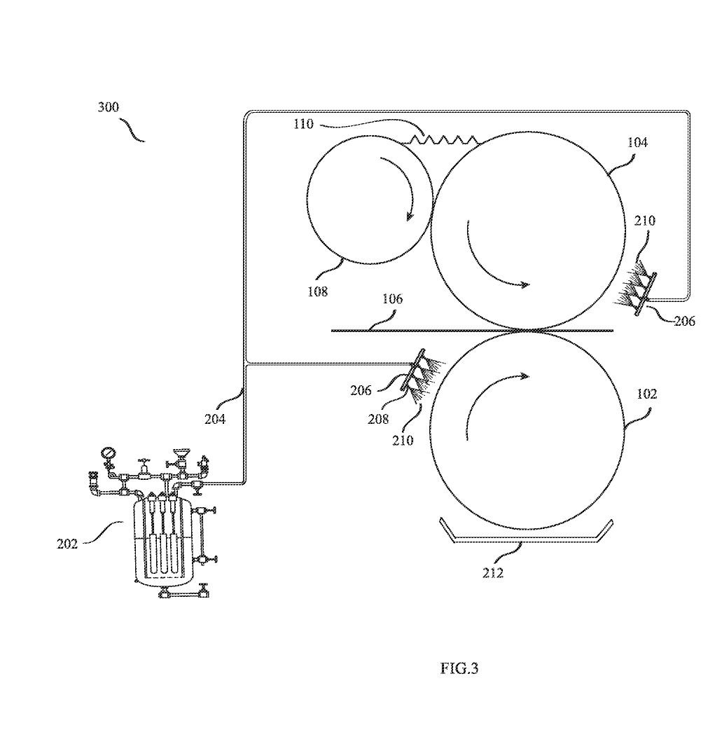

FIG. 3 illustrates an improved sheet fed coater 300 in accordance with an embodiment of the present invention. The improved sheet fed coater 300 comprises of conventional sheet fed coater 100 and the steam system 200 proposed by the present invention. As shown in FIG. 3 each of the headers 206 is positioned in such a way that the steam spray 210 hit the targeted roller. In a preferred embodiment of the present invention, the headers 206 can be positioned at any desired distance from a roller and also can be positioned at any desired direction. The steam system 200 allows regulation of pressure, temperature and direction of steam spray 210. In FIG. 3 one steam spray 210 is shown to be directed to the transport roller 102 before the beginning of the coating process of the substrate 106 another header 210 is directed to the coating roller 104 just where the substrate 106 leaves contact with the coating roller 104. The steam sprayed/injected gets condensed in coming with contact with the transport roller 102 and this layer of water or solvent (depending on what is being used for steam generation) helps to keep the surface of the transport roller 102 lubricated. Similarly, the steam spray 210 over coating roller 104 helps in keeping the coating roller surface at the exit of the coating process lubricated and, thus, helps in avoiding pasting of the substrate 106 onto the coating roller 104 after the application of the coating. If pasting of the substrate 106 onto the coating roller 104 can be prevented, then the use of clamps to hold and remove the substrate 106 can also be avoided which makes it possible to apply coating substance 110 up to the leading edge of the substrate 106.

The spray/injection of steam on the coating roller 104 also helps to prevent drying of the coating substance 110 on the surface of the coating roller 104 after application of the coating on the substrate 106. The coating substance 110, when starts to dry up, becomes stickier which aggravates the problem of substrate 106 getting stuck to surface of the coating roller 104. Application of steam over the surface of the coating roller 104 helps in avoiding this situation. Also, if the coating substance 110 dries up on the surface then it leads of build-up of dry scales of coating substance 110 which adversely affects the quality and performance of coating process. These advantages of the improved sheet fed coater 300 results in increased productivity. The application of steam helps in keeping the substrate 106 uncurled after a water based coating substance 110 is applied on it in lighter or heavier amount of coating per square meter. The amount of steam injected/sprayed on coating roller 104 should be regulated in such a way that the coating substance 110 does not get diluted due to addition of steam condensate.

The part of the condensate of the injected steam can get carried away with the substrate and this can be removed from the substrate at a later stage by heating/drying the substrate. The condensate accumulated on the rollers can be collected with the help of condensate collector 212. The collected condensate can be reused for steam generation or be discarded as per requirement.

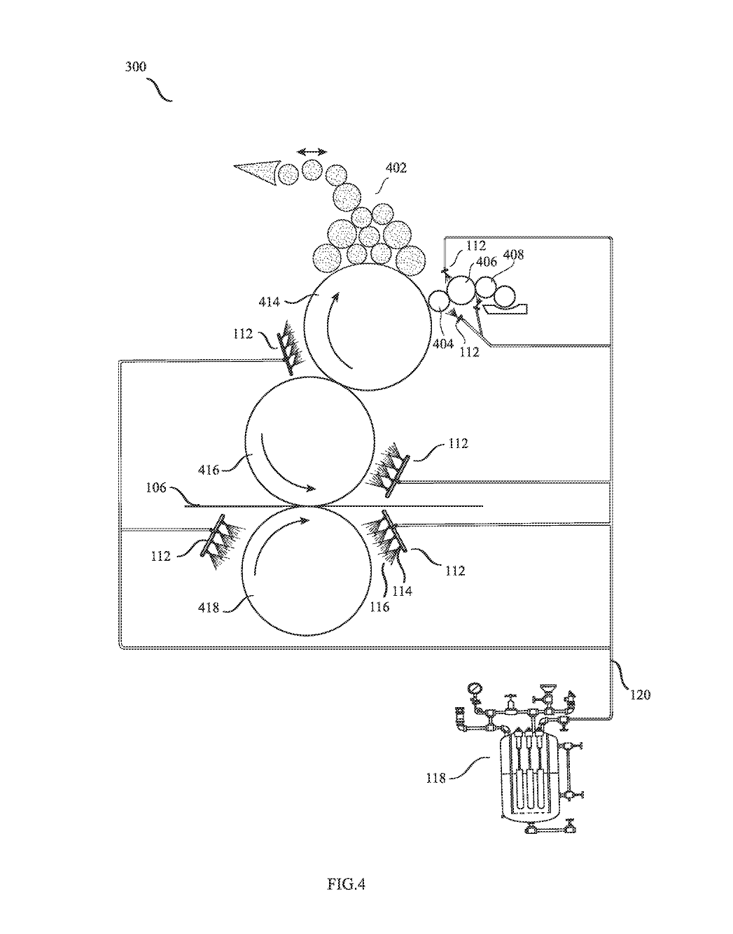

FIG. 4 illustrates an improved offset press coater as per an embodiment of the present invention. Offset press are often used to apply primers and/or varnishes with the printing rollers in general. As shown in FIG. 4, plurality of headers 112 can be positioned at multiple locations to inject/spray steam to plurality of rollers. The headers 112 are positioned to inject steam on the blanket roller 416 and on the impression roller 418 at the exit of the substrate 106 from the said two rollers. As shown in FIG. 4, 402 is the inking system. The blanket roller 416 picks up the coating substance and transfers it to the substrate 106 which is being transported by the impression cylinder 416. Header 112 is also directed to the plate roller 414 and to the form roller 404; plate roller 414 receiving the coating substance from the form roller 404. Steam is also injected/sprayed on transfer roller 406 and slip roller 408.

The application of steam in the coating process as proposed by the present invention can be regulated as per the need of the coating process. In some embodiments, instead of steam, an environment of mist can be created around the rollers to achieve the same kind of benefits as described in the above paragraphs for improving performance of sheet fed and web fed coaters in coating lightweight and/or thin substrates.

Although the system and method of the present invention has been described herein with the help of a metering roll system top coater and an offset printing press, it would be obvious to any person ordinarily skilled in the art that the inventive concept can be applied to improve the performance of any sheet fed and web fed coaters. It is reiterated that the terms “sheet fed coater”, “conventional sheet fed coater” and “improved sheet fed coater” have been used to include all such coaters including “web fed coater”, “conventional web fed coater” and “improved web fed coater” respectively. Examples of sheet fed coaters which can be improved by applying the system and method of the present invention includes, but not limited to—
1. Metering blade coaters
2. Offset coaters
3. Enclosed chamber doctor blade coaters
4. Metering roll system bottom coaters
5. Metering roll reverse coaters
6. Single offset pressure roll coaters
7. Gravure system coaters
8. Reverse roll coaters
9. Direct roll coaters
10. Continuous dampened coaters
11. Transfer roll coaters
12. Post application metering coaters
13. Web coaters
14. Web guide roll coaters
15. Dual roll feed roll coaters
16. Pressure roll arrangements coaters
17. Single feed roll coaters.

Throughout this specification and the claims attached hereto, whenever the word “rolls” or “roll” or “rollers” or any grammatical derivation thereof is used, unless it is qualified, it is to be taken as extending to one or more of the rolls mounted on a roll-coating head, which in use coats a travelling sheet or web of substrate. Therefore, the term “roll” or “rolls” or “rollers” or “cylinders” may include pick-up rolls, metering rolls, intermediate rolls, applicator rolls, anilox rolls, rotogravure rolls, meyer bar rolls and the like.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims.

What is claimed is:

1. A system for improved sheet fed coater, comprising:
a conventional sheet fed coater; and
a steam system having one or more headers;
wherein steam spray from said one or more headers hit one or more rollers of said conventional sheet fed coater thereby preventing a lightweight thin substrate from being pasted onto said one or more rollers.

2. The system for improved sheet fed coater as in claim 1, wherein said lightweight thin substrate is coated up to the extreme ends in said improved sheet fed coater as said lightweight thin substrate does not need clamps to pull away from said improved sheet fed coater.

3. The system for improved sheet fed coater as in claim 1, wherein drying of a coating substance is avoided on said one or more rollers of said conventional sheet fed coater due to use of said steam spray over said one or more rollers.

4. The system for improved sheet fed coater as in claim 3, wherein build-up of said coating substance is prevented on the said one or more rollers of said conventional sheet fed coater due to said use of said steam spray over said one or more rollers.

5. The system for improved sheet fed coater as in claim 3, wherein said steam is generated from water or any solvent known in the art depending on type of said coating substance used.

6. The system for improved sheet fed coater as in claim 1, wherein said lightweight thin substrate has a basis weight below 150 gsm.

7. The system for improved sheet fed coater as in claim 1, wherein said lightweight thin substrate has a thickness below 180 microns.

8. The system for improved sheet fed coater as in claim 1, wherein said lightweight thin substrate has a bending moment stiffness of less than 81 mNm in Machine Direction (MD) and less than 61 mNm in Cross Direction (CD).

9. The system for improved sheet fed coater as in claim 1, wherein said steam system comprises of a steam generator, one or more pipelines, one or more headers and a steam condensate collector.

10. The system for improved sheet fed coater as in claim 9, wherein said steam generator is a fuel fired boiler or electrical boiler or any other conventional type of device capable of generating steam from a fluid.

11. The system for improved sheet fed coater as in claim 9, wherein said one or more headers comprises of one or more nozzles for releasing steam spray.

12. The system for improved sheet fed coater as in claim 9, wherein said one or more headers are positioned at any desired distance from said one or more roller and are positioned at any desired direction.

13. The system for improved sheet fed coater as in claim 1, wherein said steam system is regulated as per requirement.

14. The system for improved sheet fed coater as in claim 1, wherein an environment of mist is created around said one or more rollers of said conventional sheet fed coater which prevents said lightweight thin substrate from being pasted onto said one or more rollers.

15. The system for improved sheet fed coater as in claim 1, wherein use of said steam system prevents said lightweight thin substrate from becoming curled.

16. A method for improved sheet fed coater, said method comprising the steps of:
using a steam system having one or more headers with a conventional sheet fed coater for coating a lightweight thin substrate;
positioning said one or more headers in such a way that a steam spray hit one or more targeted rollers of said conventional sheet fed coater; and
releasing said steam spray to hit said one or more targeted rollers of said conventional sheet fed coater;
wherein said steam spray lubricates said one or more targeted rollers' surfaces and helps in avoiding pasting of a lightweight thin substrate being coated in said conventional sheet fed coater onto said one or more targeted rollers.

17. The method for improved sheet fed coater as in claim 16, wherein said steam spray is directed to a coating roller of said one or more rollers at the point where said lightweight substrate leaves said coating roller.

18. The method for improved sheet fed coater as in claim 16, wherein said steam spray is directed to a transport roller of said one or more rollers before said lightweight substrate touches said transport roller.

19. The method for improved sheet fed coater as in claim 16, further comprises collecting the condensate accumulated on the said targeted rollers in a condensate collector.
